(19) United States
(12) Patent Application Publication
(10) Pub. No.: US 2009/0021508 A1
(43) Pub. Date: Jan. 22, 2009

(54) Light source module for display device and display device having the same

(75) Inventors: Byoung-Dae Ye, Yongin-si (KR); Gi-Cherl Kim, Yongin-si (KR); Byung-Choon Yang, Seoul (KR); Eui-Jeong Kang, Asan-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/218,850

(22) Filed: Jul. 18, 2008

(30) Foreign Application Priority Data
Jul. 20, 2007 (KR) 10-2007-0072998

(51) Int. Cl. G06F 3/038

(52) U.S. Cl. 345/212

(57) ABSTRACT

A light source module comprises a light source including a plurality of light emitting units and a voltage current source for supplying driving power to the light source according to a plurality of luminance control signals. The luminance control signals are dimming signals. The light source module also comprises a multi-channel current controller for adjusting luminance of the plurality of light emitting units respectively according to the plurality of luminance control signals.

This application claims priority to Korean Patent application No. 10-2007-0072998, filed on Jul. 20, 2007 and all the benefits accruing therefrom under 35 U.S.C. 119, the contents of which are herein incorporated by reference in its entirety.

### BACKGROUND OF THE DISCLOSURE

1. Field of the Invention

The present invention relates to a light source module for a display device and a display device having the same, and more particularly, to a light source module for a display device capable of reducing power consumption through efficient multi-channel current control.

2. Description of the Related Art

In general, a liquid crystal display device, for example a flat display device, is a light receiving device that does not emit light by itself. The liquid crystal display device displays an image using light emitted from a separate light source module, for example a backlight. The light source module includes a light source and a light source driver for driving the light source.

In order to be lightweight and thin, a light source module is manufactured using light emitting diodes as the light source. The voltage/current characteristic of a light source module with light emitting diodes is a critical factor in manufacturing a high quality display device. Recently, in order to improve the contrast ratio, light emitting diodes have been grouped into blocks and the brightness of each block adjusted, for example by dimming, using a light source driver. In such an arrangement, however, a driver circuit for driving the light emitting diodes may become complicated, and power consumption increased since current of a constant level should be continuously supplied to each block.

### SUMMARY OF THE DISCLOSURE

Example embodiments of the present disclosure provide a light source module for a display device and a display device having the same, in which the brightness of each light emitting diode block is adjusted and a voltage current source is controlled using luminance control signals to thereby minimize power consumption.

According to an example embodiment of the present invention, a light source module is provided, including a light source having a plurality of light emitting units; a voltage current source for supplying driving power to the light source according to a plurality of luminance control signals, the luminance control signals being dimming signals; and a multi-channel current controller for adjusting luminance of the plurality of light emitting units respectively according to the plurality of luminance control signals. Each of the plurality of light emitting units may include a plurality of light emitting diodes.

Each of the plurality of luminance control signals may be a pulse width modulation signal.

The multi-channel current controller may include a power controller for keeping the power applied to the plurality of light emitting units to be constant; and a luminance adjustor for controlling a pulse width of the power applied to the plurality of light emitting units according to the luminance control signals.

The voltage controller may include a current mirror, and the luminance adjustor may include a transistor for electrically connecting the plurality of light emitting units and a ground according to the luminance control signals.

The voltage current source may include an operation controller for generating a control signal according to the plurality of luminance control signals; and a power converter for providing the driving power to the light source in response to the control signal.

The operation controller may generate the control signal through a logical combination of the plurality of luminance control signals.

The operation controller may generate the control signal to disable the power converter when all the plurality of luminance control signals are logic low.

The power converter may include a pulse signal generator for generating a pulse signal in response to the control signal; and an output unit for converting and outputting external power applied according to the pulse signal.

The power converter may include a switch for controlling input of external power in response to the control signal; and an output unit for generating the driving power according to the external power.

According to another example embodiment of the present disclosure, a method for driving a light source module is provided, including providing a driving power to a plurality of light emitting units; providing a plurality of luminance control signals, as dimming signals, to a multi-channel current controller connected to the plurality of light emitting units to allow the plurality of light emitting units to emit light; and controlling operation of a voltage current source using the plurality of luminance control signals, the voltage current source providing the driving power to the plurality of light emitting units.

The method may further include generating a control signal having a variable logic level according to a logic level of the plurality of luminance control signals; and controlling operation of the voltage current source according to the logic level of the control signal.

When all the plurality of luminance control signals are logic low, the control signal may become logic low or logic high.

The plurality of luminance control signals may correspond to the plurality of light emitting units, respectively, and the multi-channel current controller may control luminance of the respective light emitting units according to a pulse width of a logic high section of the plurality of luminance control signals in a logic high section of the luminance control signals.

According to a further embodiment of the present invention, a display device is provided, including a display panel; a controller for controlling operation of the display panel; a light source which includes a plurality of light emitting units and provides light to the display panel; a voltage current source for supplying driving power to the light source according to a plurality of luminance control signals, the luminance control signals being dimming signals; and a multi-channel current controller for adjusting luminance of the plurality of light emitting units respectively according to the plurality of luminance control signals.

Each of the plurality of luminance control signals may be a pulse width modulation signal.

The multi-channel current controller may include a power controller for keeping the power applied to the plurality of light emitting units to be constant; and a luminance adjustor for controlling a pulse width of the power applied to the plurality of light emitting units respectively according to the luminance control signals.

The voltage current source may include an operation controller for generating a control signal according to a logical combination of the plurality of luminance control signals; and a power converter for providing the driving power to the light source in response to the control signal.

At least one of the voltage current source and the multi-channel current controller may be manufactured in the form of an IC chip.

### BRIEF DESCRIPTION OF THE DRAWINGS

Preferred embodiments of the present invention may be understood in more detail from the following description taken in conjunction with the accompanying drawings, in which:

FIG. 1 is a block diagram illustrating a display device according to an exemplary embodiment of the present disclosure;

FIG. 2 is a block diagram illustrating a light source module according to the exemplary embodiment of the present disclosure;

FIG. 3 is a circuit diagram of a multi-channel current controller according to the exemplary embodiment of the present disclosure;

FIG. 4 is a block diagram of a voltage current source according to the exemplary embodiment of the present disclosure;

FIG. 5 is a circuit diagram of an operation controller according to the exemplary embodiment of the present disclosure; and

FIG. 6 is a block diagram of a voltage current source according to a variant of the exemplary embodiment of the present disclosure.

### DESCRIPTION OF THE PREFERRED EMBODIMENT

Hereinafter, exemplary embodiments of the present invention will be described in detail with reference to the accompanying drawings. However, the present invention is not limited to the embodiments disclosed below but may be implemented into different forms. These embodiments are provided only for illustrative purposes and for full understanding of the scope of the present invention by those skilled in the art.

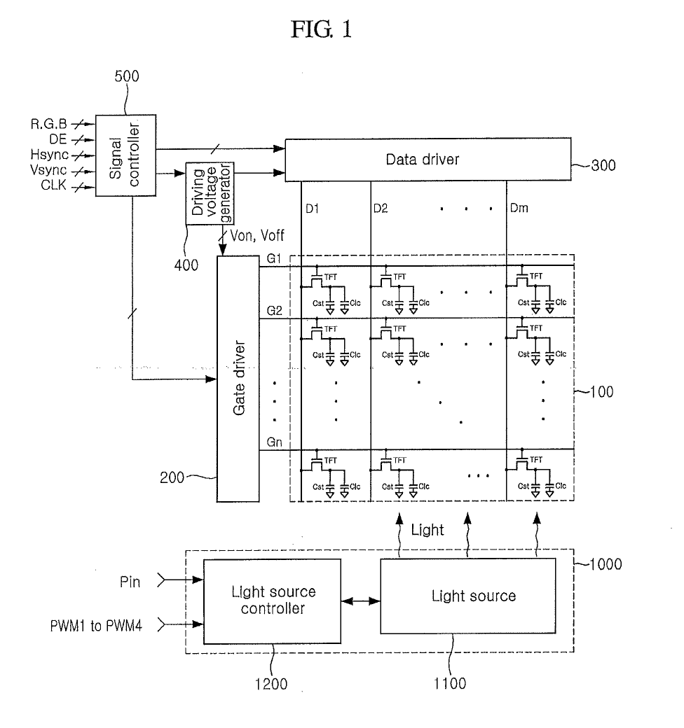

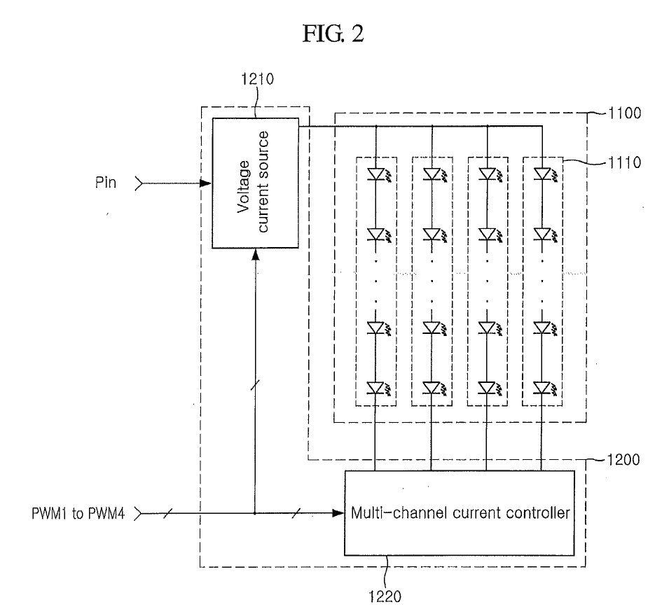

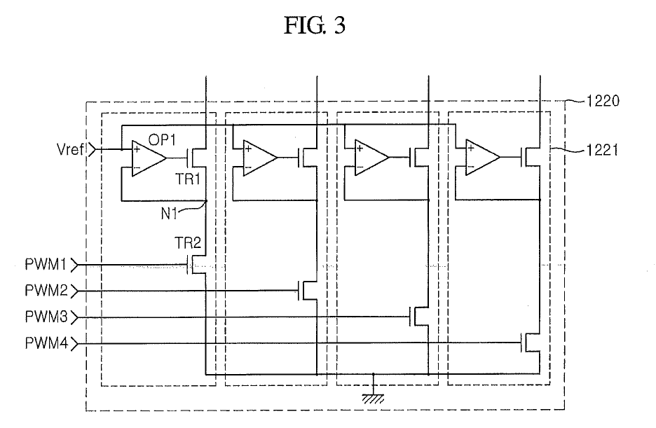

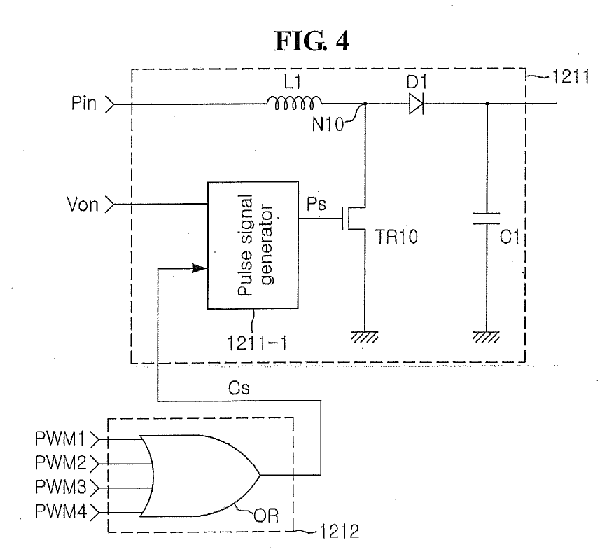

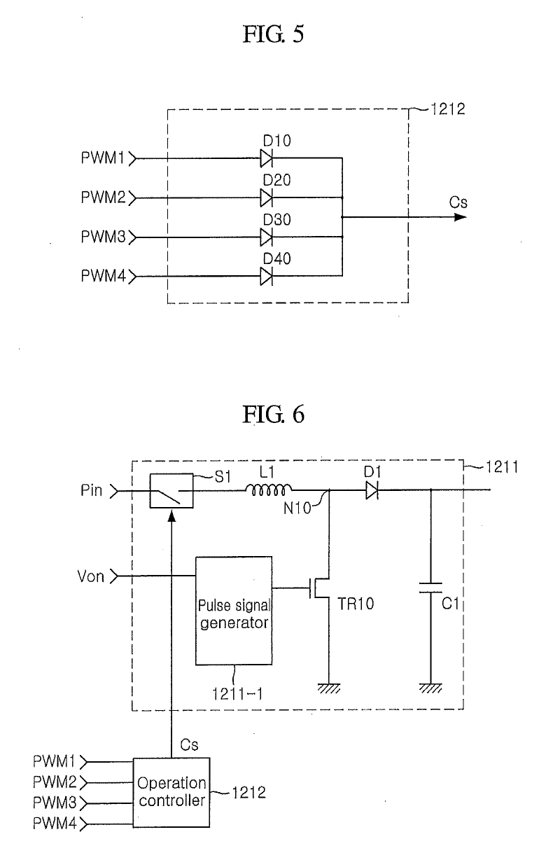

FIG. 1 is a block diagram illustrating a display device according to an exemplary embodiment of the present invention. FIG. 2 is a block diagram illustrating a light source module according to an exemplary embodiment of the present invention. FIG. 3 is a circuit diagram of a multi-channel current controller according to an exemplary embodiment of the present invention. FIG. 4 is a block diagram of a voltage current source according to an exemplary embodiment of the present invention. FIG. 5 is a circuit diagram of an operation controller according to an exemplary embodiment of the present invention. FIG. 6 is a block diagram of a voltage current source according to a further exemplary embodiment of the present invention.

Referring to FIGS. 1 to 5, a display device according to an exemplary embodiment may include a display panel 100, a gate driver 200, a data driver 300, a driving voltage generator 400, a signal controller 500, and a light source module 1000.

The display panel 100 may be driven by the gate driver 200 and the data driver 300 and may display an image according to light from the light source module 1000. The display panel 100 includes a plurality of gate lines G1 to Gn, a plurality of data lines D1 to Dm, and a plurality of unit pixels, as shown in FIG. 1. The plurality of gate lines G1 to Gn extend in one direction and the plurality of data lines D1 to Dm extend in a direction intersecting the plurality of gate lines G1 to Gn. At least one end of each of the plurality of gate lines G0 to Gn is connected to the gate driver 200. At least one end of each of the plurality of data lines D1 to Dm is connected to the data driver 300.

Unit pixels may be provided at intersections of the gate lines G1 to Gn and the data lines D1 to Dm. Each unit pixel may include a thin film transistor T, a storage capacitor Cst, and a liquid crystal capacitor Clc, as shown in FIG. 1. The liquid crystal capacitor Clc may include a lower pixel electrode, an upper common electrode, and a liquid crystal provided between the pixel electrode and the common electrode. Although not shown, a color filter may be disposed on the liquid crystal capacitor Clc. The pixel electrode and the common electrode may be divided into a plurality of domains.

The display panel 100 according to this exemplary embodiment is not limited to the aforementioned structure but may be changed in various forms. For example, a plurality of pixels may be provided in a unit pixel area. An abscissa length of the unit pixel area may be longer or shorter than an ordinate length. The unit pixel area may also have various shapes other than a rectangular shape.

Controllers for providing signals for driving the display panel 100 may be provided outside the display panel 100 having the aforementioned structure. The controllers may include a gate driver 200, a data driver 300, a driving voltage generator 400, and a signal controller 500.

During normal operation, the signal controller 500 receives an input image signal and an input control signal from an external graphic controller (not shown). The input image signal may include pixel data R, G and B. The input control signal controls display of input image signal. The input control signal includes a vertical synchronization signal Vsync, a horizontal synchronization signal Hsync, a main clock CLK, and a data enable signal DE.

The signal controller 500 processes pixel data according to an operational condition of the display panel 100. Accordingly, the pixel data are rearranged according to the arrangement of pixels, the pixel arrangement, of a corresponding liquid crystal display panel 100. In addition, the signal controller 500 generates a gate control signal and a data control signal, and sends the gate control signal to the gate driver 200 and the data control signal to the data driver 300. The gate control signal may include a vertical synchronization start signal indicating output start of the gate turn on voltage Von, a gate clock signal, and an output enable signal. The data control signal may include a synchronization start signal indicating transmission start of pixel data, a load signal instructing a data voltage to be applied to a corresponding data line, a reverse signal for reversing a polarity of a gray scale voltage with respect to a common voltage, and a data clock signal.

The driving voltage generator 400 may generate various driving voltages required for driving the display device using an external voltage from an external power supply. For example, the driving voltage generator 400 may generate a reference voltage, a gate turn on voltage Von, a gate turn off voltage Voff, and a common voltage. In response to the control signal from the signal controller 500, the driving voltage generator 400 applies the gate turn on voltage Von and the gate turn off voltage Voff to the gate driver 200 and applies the reference voltage to the data driver 300. Here, the reference voltage may be used for generating a gray scale voltage for driving the liquid crystal.

In an example embodiment, the gate driver 200 may be connected to the plurality of gate lines G1 to Gn, and may sequentially provide the gate turn on voltage Von of the driving voltage generator 400 to the plurality of gate lines G1 to Gn in response to the control signal of the signal controller 500. In this way, the operation of the thin film transistors T can be controlled.

In an example embodiment, the data driver 300 may be connected to the plurality of data lines D1 to Dm, and may generate the gray scale voltage using the control signal of the signal controller 500 and the reference voltage GVDD of the driving voltage generator 400. The data driver 300 may apply the corresponding gray scale voltage to the respective data lines D1 to Dm. That is, the data driver 300 may convert the input digital pixel data into an analog data signal (i.e., the gray scale voltage) based on the reference voltage, and may output an analog data signal.

In an example embodiment, the signal controller 500, the driving voltage generator 400, the data driver 300 and the gate driver 200 may be manufactured in the form of an IC chip and mounted on a printed circuit board (PCB). The printed circuit board may be electrically connected to the display panel 100 via a flexible printed circuit board (FPC). In an example embodiment, the display panel 100 may include upper and lower substrates. The substrates may be, for example, a glass substrate or a light-transmitting plastic substrate. In one embodiment, the gate driver 200 and data driver 300 may be mounted on the light-transmitting substrate of the display panel 100. The gate driver 200 may be formed in a stage form on the lower substrate of the display panel 100. That is, when the thin film transistors T are manufactured on the lower substrate, the gate driver 200 may be manufactured together with the thin film transistors T.

The light source module 1000 may include a light source 1100 for providing light to the display panel 100, and a light source controller 1200 for controlling the operation of the light source 1100, as shown in FIG. 1.

The light source 1100 may include a plurality of light emitting units 1110 connected in parallel between input and output nodes. Although the light source 1100 having four light emitting units 1110 is shown in FIG. 2, the number of the light emitting units 1110 is not limited thereto but may be more or less than 4. Alternatively, the plurality of light emitting units 1110 may be connected in series and/or in anti-parallel.

Each of the light emitting units 1110 may include a plurality of light emitting diodes. The plurality of light emitting diodes in a light emitting unit 1110 may be connected in series, as shown in FIG. 2. The present invention is not limited thereto, but the light emitting diodes may be connected in parallel and/or in anti-parallel. The respective light emitting units 1110 may have the same number of light emitting diodes. The light emitting unit 1110 may include a substrate (not shown) having a plurality of light emitting diodes mounted thereon, and power supply terminals (not shown) for supplying power to the light emitting diodes. Each of the light emitting units 1110 may emit light as one channel.

In an example embodiment, the light source controller 1200 may include a voltage current source 1210 and a multi-channel current controller 1220 as shown in FIG. 2. The voltage current source 1210 may be driven by external power and a plurality of luminance control signals PWM1 to PWM4, and may supply driving power to the light sources 1100. The multi-channel current controller 1220 may adjust the luminance of the light source 1100 according to the luminance control signals PWM1 to PWM4. The voltage current source 1210 may be an externally supplied input to DC power Pin. The voltage current source 1210 may supply DC power to the plurality of light emitting units 1110. The multi-channel current controller 1220 may adjust luminance of the light source 1110 according to the luminance control signals PWM1 to PWM4. The plurality of luminance control signals PWM1 to PWM4 may be dimming signals provided by the external graphic controller. For example, the luminance control signals PWM1 to PWM4 may be signals of various forms that can control the luminance of the light emitting units 1110. In an example embodiment, pulse width modulation signals may be used as the luminance control signals PWM1 to PWM4. That is, the luminance control signals PWM1 to PWM4 may be in the form of a square wave pulse, of which the duty rate may be variously adjusted. The respective luminance control signals PWM1 to PWM4 may have the same amplitude. The present invention is not limited thereto, but the luminance control signals PWM1 to PWM4 may also be pulse amplitude modulation signals, pulse phase modulation signals, and/or pulse frequency modulation signals.

The light source controller 1200 may be manufactured in the form of an IC chip and mounted on a printed circuit board. The printed circuit board may be connected to the power supply terminals of the light emitting unit 1110 using connection terminals, such as connectors. A terminal connected to the voltage current source 1210 is connected to an input terminal of the light source 1100, and a terminal connected to the multi-channel current controller 1220 is connected to an output terminal of the light source 1100. The present invention is not limited thereto, but the voltage current source 1210 and the multi-channel current controller 1220 in the light source controller 1200 may be manufactured in the form of separate IC chips and mounted on the printed circuit board. Alternatively, they may be manufactured on a printed circuit board in the form of general circuits rather than IC chips.

In an exemplary embodiment, the multi-channel current controller 1220 may include a plurality of luminance controllers 1221, which are respectively connected to the light emitting units 1110 and control the luminance of the light emitting units 1110 according to the plurality of luminance control signals PWM1 to PWM4. In this exemplary embodiment, since there are four light emitting units 1110, the four luminance controllers 1221 and the four luminance control signals PWM1 to PWM4 are used. The number is not limited thereto as mentioned above but may vary. The plurality of luminance controllers 1221 convert the DC power provided to the light emitting unit 1110 into a waveform having a predetermined period, and control the luminance of the light emitting units 1110. That is the luminance controllers 1221 maintain the amplitude of the supplied power applied to both ends of the light emitting unit 1110 connected to each luminance controller 1221, and change the pulse width of the supplied power, in accordance with and responsive to the luminance control signals PWM1 to PWM4. Thus, the luminance of the light emitting diodes in the light emitting unit 1110 may be maintained at a uniform level. The luminance of the light emitting diodes in the light emitting unit 1110 may vary greatly depending on the amplitude of the supplied power. Accordingly, in this exemplary embodiment, the luminance controllers 1221 control the pulse width of the power supplied to the light emitting diodes while maintaining the amplitude of the power applied to the light emitting diodes to be constant. That is, the controllers 1221 adjust luminance (brightness) of the entire light emitting units by adjusting the power supplying time while maintaining constant power amplitude.

In an example embodiment, each of the luminance controllers 1221 may include a voltage comparator OP1, a first transistor TRk, and a second transistor TR2 as shown in FIG. 3. The voltage comparator OP1 may compare a voltage at a first node N1 with the reference voltage Vref. The first transistor TR1 may be connected between an input terminal (i.e., the light emitting unit 1110) and the first node N1, and may be driven by output of the voltage comparator OP1. The second transistor TR2 may be connected between the first node N1 and a ground, and may be driven by the luminance control signals PWM1 to PWM4. The voltage comparator OP1 may be an OP amplifier. In an exemplary embodiment, a non-inverting terminal (+) of the OP amplifier may be connected to the reference voltage input terminal, and an inverting terminal (−) thereof may be connected to the first node N1. The same reference voltage Vref may be applied to the plurality of luminance controllers 1221.

The above circuit has been described merely as an example of the luminance controller 1221, but the present invention is not limited thereto. That is, the luminance controller 1221 may include a power controller for keeping the power applied to the plurality of light emitting units 1110 to be constant, and a luminance adjustor for freely adjusting the luminance of the light emitting diodes in the light emitting unit 1110 by changing the pulse width of the power supplied to the plurality of light emitting units 1110. Further, various circuits capable of freely adjusting the brightness of each light emitting unit 1110 including the light emitting diodes may be used. For example, the luminance controller 1221 may include a current mirror for making the amplitude of current flowing through the plurality of light emitting units 1110 constant. The current mirror may be manufactured by combining various circuits.

As described above, the luminance control signals PWM1 to PWM4 are square wave pulses. Thus, the luminance controller 1221 allows the light emitting units 1110 to emit light during a logic high section of the luminance control signals PWM1 to PWM4. The luminance controller 1221 controls the pulse width of the logic high section to adjust the brightness of the light emitting units 1110.

In an exemplary embodiment, the voltage current source 1210 may include an operation controller 1212 and a power converter 1211 as shown in FIG. 4. The operation controller 1212 may generate a control signal Cs according to the plurality of luminance control signals PWM1 to PWM4. The power converter 1211 may operate according to the control signal Cs and may generate the driving power. The voltage current source 1210 may be manufactured in a form of an IC chip. The present invention is not limited thereto, but each of the operation controller 1212 and the power converter 1211 may be manufactured in a form of an IC chip and electrically connected to the light source 1100.

The voltage current source 1210 may detect a section in which the light source 1100 does not emit light (i.e., a section in which the plurality of luminance control signals PWM1 to PWM4 are logic low), and may disable the power converter 1211 in such a section, thereby reducing power consumption. If, on the other hand, the voltage current source 1210 continues operation during the section in which the light source 1100 does not emit light, the voltage current source 1210 continues to generate the driving power in the section. Then the generated driving power may be wasted without being used to operate the light emitting units 1110 in the light source, thereby increasing power consumption. In an exemplary embodiment, however, the section in which the light sources 1100 do not emit light may be detected using the luminance control signals PWM1 to PWM4, so that the voltage current source 1210 may be kept in a standby mode in which the voltage current source 1210 is instantaneously disabled.

In an exemplary embodiment, the operation controller 1212 may generate the control signal Cs by performing OR and/or AND operations on the plurality of luminance control signals PWM1 to PWM4. As shown in FIG. 4, the operation controller 1212 generates the control signal Cs by performing OR operation on the plurality of luminance control signals PWM1 to PWM4. The operation controller 1212 may include an OR gate that receives the plurality of luminance control signals PWM1 to PWM4.

Therefore, in a section where all the plurality of luminance control signals PWM1 to PWM4 are in a logic low state, the operation controller 1212 may supply the control signal Cs having a logic low level to the power converter 1211. Accordingly, the power converter 1211 may come to a standby state and stop operating. When all the luminance control signals PWM1 to PWM4 are logic low, all the light emitting units 1110 in the light source 1100 do not emit light, that is, the light source does not emit light. In this exemplary embodiment, the section in which the light source does not emit light is detected by the operation controller 1212. As such, the power consumption of the power converter 1211 may be reduced. In addition, the plurality of luminance control signals corresponds to the plurality of light emitting units respectively. Therefore, when at least one light emitting unit 1110 emits light (i.e., at least one of the luminance control signals PWM1 to PWM4 is logic high), the operation controller 1212 supplies the control signal Cs of a logic high level to the power converter 1211. Accordingly, the power converter 1211 operates normally. It has been described above that the power converter 1211 may not operate when the control signal Cs is logic low. However, the present invention is not limited thereto, but the power converter 1211 may not operate when the control signal Cs is logic high. The logic level of the control signal Cs may be changed by means of a signal level changing unit, such as an inverter. For example, in a case where the control signal Cs is in a logic low or logic high level, the inverter may change the logic level of the control signal Cs and provide the changed signal to the power converter 1211.

In an exemplary embodiment, the operation controller 1212 may include four diodes D10, D20, D30 and D40 respectively provided between input terminals for receiving the four luminance control signals PWM1 to PWM4 and an output terminal, as shown in FIG. 5. Anodes of the four diodes D10, D20, D30 and D40 may be connected to the respective input terminals of the luminance control signals, and cathodes thereof may be connected to the output terminal. The present invention is not limited thereto, but the operation controller 1212 may be a NAND gate or a NOR gate.

The power converter 1211 may include a pulse signal generator 1211-1 and an output unit. The pulse signal generator 1211-1 may generate a pulse signal Ps in response to the control signal Cs from the operation controller 1212. The output unit may convert and output an input DC power Pin applied in response to the pulse signal Ps.

In an exemplary embodiment, the output unit boosts the voltage of the input DC power Pin and outputs the power. The output unit may include: an inductor L1 provided between the DC power input terminal and a tenth node N10; a tenth transistor TR10 provided between the tenth node N10 and a ground, and operating according to the pulse signal Ps; a rectifying diode D1 provided between the tenth node N10 and the DC power output terminal; and a capacitor C1 provided between the DC power output terminal and the ground, as shown in FIG. 4.

When the tenth transistor TR10 is turned on by the pulse signal Ps, a current path is formed between the DC power input terminal and the ground. Accordingly, an amount of current flowing through the inductor L1 is increased in proportion to time. As the input current flows through the inductor L1, its energy is stored in the inductor L1. When the tenth transistor T10 is turned off by the pulse signal Ps, the current path between the DC power input terminal and the ground is blocked and the current flowing through the inductor L1 is also blocked. Accordingly, high voltage is generated in the inductor L1 by a counter electromotive force of high energy. The high voltage may turn on the rectifying diode D1 and allow the current accumulated in the inductor L1 as a magnetic field to flow through the rectifying diode D1, so that charges are accumulated in the capacitor C1. The power charged in the capacitor C1 may be used to be supplied to the light source.

The pulse signal generator 1211-1 may be driven by driving voltage and the control signal Cs and generating a square wave pulse signal. The pulse signal generator 1211-1 may adjust a duty ratio of the square wave pulse, so that the power converter 1211 outputs a constant DC voltage. The pulse signal generator 1211-1 may receive a feedback signal from the output unit to adjust the duty ratio of the square wave pulse.

The power converter 1211 according to this exemplary embodiment is not limited to the above circuit but may be changed into various forms.

For example, as shown in FIG. 6, the power converter 1211 may include a switch S1 which is provided between the external power input terminal and the inductor L1 and operates according to the control signal Cs from the operation controller 1212. The switch S1 may be a device, such as a transistor or a transfer gate, controlling the transfer of the voltage (signal) in response to a predetermined signal. The switch S1 may be turned on/off by the control signal Cs, and may control the external power input to the power converter. For example, the switch S1 including a transistor can be described as follows. When the control signal Cs is logic high (i.e., when it is higher than a threshold voltage), the transistor is turned on and the external power is provided to the inductor L1. Accordingly, the power converter 1211 operates normally. However, when the control signal Cs is logic low (when it is lower than the threshold voltage), the transistor is turned off and the external power is blocked. Thus, operation of the entire power converter 1211 may be controlled through the control signal Cs. Here, the position of the switch S1 is not limited thereto, but the switch S1 may be located between the inductor L1 and the rectifying diode D1 and/or between the rectifying diode and the output terminal.

The operation of the light source module having the above configuration according to this exemplary embodiment will now be described.

In an exemplary embodiment, the luminance of the plurality of light emitting units 1110 may be adjusted by providing the DC power and the plurality of luminance control signals PWM1 to PWM4 to the power converter 1211, which provides driving power to the light source 1100 having the plurality of light emitting units 1110, and by providing the plurality of luminance control signals PWM1 to PWM4 to the multi-channel current controller 1220. In addition, the operation of the power converter may be controlled according to the plurality of luminance control signals PWM1 to PWM4.

For example, the power converter 1211 may receive the DC power from an external system, and the operation controller 1212 and the multi-channel current controller 1220 may receive the plurality of luminance control signals PWM1 to PWM4.

The operation controller 1212 may generate the control signal Cs according to the plurality of luminance control signals PWM1 to PWM4. The operation controller 1212 may change the logic level of the control signal Cs according to the logic level of the plurality of luminance control signals PWM1 to PWM4. For example, when all the plurality of luminance control signals PWM1 to PWM4 are logic low, the operation controller 1212 generates the control signal Cs of a logic low level. Meanwhile, when at least one of the plurality of the luminance control signals PWM1 to PWM4 are logic high, the operation controller 1212 generates the control signal Cs of a logic high level.

The power converter 1211 may operate normally when the control signal Cs of a logic high level is applied. That is, the power converter 1211 may generate the driving power using the input DC power. The power converter 1211 may provide the generated driving power to the plurality of light emitting units 1110. The plurality of light emitting units 1110 may emit light by the driving power provided thereto. The multi-channel current controller 1220 may maintain the amount of current flowing though the plurality of light emitting units 1110 to be the same. The multi-channel current controller controls the luminance of the plurality of light emitting units 1110 respectively according to the plurality of luminance control signals PWM1 to PWM4 having a variable pulse width of a logic high section.

When the control signal Cs of a logic low level is applied, the power converter 1211 may stop operating and the driving power may not be applied to the plurality of light emitting units 1110. The multi-channel current controller 1220 reduces the luminance of a plurality of light emitting units 1110 to a minimum value according to the plurality of luminance control signals PWM1 to PWM4 with a logic low level. That is, all the light emitting units 1110 do not emit light (e.g., darkness state). In this exemplary embodiment, the plurality of light emitting units 1110 do not emit light since the driving power is not applied to the plurality of light emitting units 1110.

It has been described above that when all the plurality of luminance control signals PWM1 to PWM4 are logic low, the low control signal Cs is generated. In addition, when the control signal Cs is logic low, the power converter 1211 does not operate. The present invention is not limited thereto. For example, in another configuration, when all the plurality of luminance control signals PWM1 to PWM4 are logic high, the control signal Cs of a logic high level may be generated. Also, the power converter 1211 may be configured not to operate when the control signal Cs is logic high. In addition, there may be a case in which the control signal Cs of a logic high level is generated when all the plurality of luminance control signals PWM1 to PWM4 are logic low.

As described above, the luminance of light emitting units including a plurality of light emitting diodes is adjusted by luminance control signals and a multi-channel current controller, and the operation of a voltage current source for supplying power to a light source is controlled by the luminance control signals, whereby power consumption is minimized.

Although the present invention has been described in connection with the accompanying drawings and the preferred embodiment, the present invention is not limited thereto but defined by the appended claims. Accordingly, it will be understood by those skilled in the art that various modifications and changes can be made thereto without departing from the spirit and scope of the invention defined by the appended claims.

What is claimed is:

1. A light source module, comprising:
a light source including a plurality of light emitting units;
a voltage current source for supplying driving power to the light source according to a plurality of luminance control signals, the luminance control signals being dimming signals; and
a multi-channel current controller for adjusting luminance of the plurality of light emitting units respectively according to the plurality of luminance control signals.

2. The module as claimed in claim 1, wherein each of the plurality of light emitting units comprises a plurality of light emitting diodes.

3. The module as claimed in claim 1, wherein each of the plurality of luminance control signals is a pulse width modulation signal.

4. The module as claimed in claim 1, wherein the multi-channel current controller comprises:
a power controller for keeping the power applied to the plurality of light emitting units to be constant; and
a luminance adjustor for controlling a pulse width of the power applied to the plurality of light emitting units according to the luminance control signals.

5. The module as claimed in claim 4, wherein the voltage controller comprises a current mirror, and the luminance adjustor comprises a transistor for electrically connecting the plurality of light emitting units and a ground according to the luminance control signals.

6. The module as claimed in claim 1, wherein the voltage current source comprises:
an operation controller for generating a control signal according to the plurality of luminance control signals; and
a power converter for providing the driving power to the light source in response to the control signal.

7. The module as claimed in claim 6, wherein the operation controller generates the control signal through a logical combination of the plurality of luminance control signals.

8. The module as claimed in claim 6, wherein the operation controller generates the control signal to disable the power converter when all the plurality of luminance control signals are logic low.

9. The module as claimed in claim 6, wherein the power converter comprises:
a pulse signal generator for generating a pulse signal in response to the control signal; and
an output unit for converting and outputting external power applied according to the pulse signal.

10. The module as claimed in claim 6, wherein the power converter comprises:
a switch for controlling input of external power in response to the control signal; and
an output unit for generating the driving power according to the external power.

11. A method for driving a light source module, comprising:
providing a driving power to a plurality of light emitting units;
providing a plurality of luminance control signals, as dimming signals, to a multi-channel current controller connected to the plurality of light emitting units to allow the plurality of light emitting units to emit light; and
controlling operation of a voltage current source using the plurality of luminance control signals, the voltage current source providing the driving power to the plurality of light emitting units.

12. The method as claimed in claim 11, further comprising:
generating a control signal having a variable logic level according to a logic level of the plurality of luminance control signals; and
controlling operation of the voltage current source according to the logic level of the control signal.

13. The method as claimed in claim 12, wherein when all the plurality of luminance control signals are logic low, the control signal becomes logic low or logic high.

14. The method as claimed in claim 11, wherein the plurality of luminance control signals correspond to the plurality of light emitting units, respectively, and the multi-channel current controller controls luminance of the respective light emitting units according to a pulse width of a logic high section of the plurality of luminance control signals.

15. A display device, comprising:
a display panel;
a controller for controlling operation of the display panel;
a light source which includes a plurality of light emitting units and provides light to the display panel;
a voltage current source for supplying driving power to the light source according to a plurality of luminance control signals, the luminance control signals being dimming signals; and
a multi-channel current controller for adjusting luminance of the plurality of light emitting units respectively according to the plurality of luminance control signals.

16. The device as claimed in claim 15, wherein each of the plurality of luminance control signals is a pulse width modulation signal.

17. The device as claimed in claim 15, wherein the multi-channel current controller comprises:
a power controller for keeping the power applied to the plurality of light emitting units to be constant; and
a luminance adjustor for controlling a pulse width of the power applied to the plurality of light emitting units respectively according to the luminance control signals.

18. The device as claimed in claim 15, wherein the voltage current source comprises:
an operation controller for generating a control signal according to a logical combination of the plurality of luminance control signals; and
a power converter for providing the driving power to the light source in response to the control signal.

19. The device as claimed in claim 18, wherein at least one of the voltage current source and the multi-channel current controller is manufactured in the form of an IC chip.
